(19) United States
(12) Patent Application Publication
(10) Pub. No.: US 2016/0062426 A1
(43) Pub. Date: Mar. 3, 2016

(54) Chip Device and Electronic System thereof

(71) Applicant: Wistron Corporation, New Taipei City (TW)

(72) Inventors: Chun-Lin Lu, New Taipei City (TW); Yu-Hong Chen, New Taipei City (TW); Chen-Chang Fan, New Taipei City (TW)

(21) Appl. No.: 14/506,710

(22) Filed: Oct. 6, 2014

(30) Foreign Application Priority Data
Aug. 27, 2014 (TW) 103129579

(51) Int. Cl. G06F 1/26

(52) U.S. Cl. CPC G06F 1/26

(57) ABSTRACT

An electronic system includes a chip device, for operating an Advanced Configuration and Power Interface operating system; and a first computing device, coupled to the chip device via a first event pin and a first clock pin; wherein the first computing device transmits a first event signal to the chip device via the first event pin and transmits a first clock signal to the chip device via the first clock pin, for controlling the chip device to perform a first event.

### BACKGROUND OF THE INVENTION

1. Field of the Invention

The present invention relates to a chip device and electronic system thereof, and more particularly, to a chip device replacing system control interrupt (SCI) pins with general purpose input/output pins and electronic system thereof.

2. Description of the Prior Art

The Advanced Configuration and Power Interface (ACPI) is a computer power management specification jointly built by Intel, Microsoft, Phoenix, HP and Toshiba and is utilized for allowing the operating system to directly manage power usages of all kind of devices. The current ACPI structure defines different power modes corresponding to different situations when the computer system operates. A normal operation status G0 comprises a mode S0, a sleep status G1 comprises modes S1-S4 and a power-off status G2 comprises a mode S5. The details of providing powers to main components of the computer system under the modes S0-S5 are narrated in the following descriptions:

Mode S0: Provide the powers to all of the components, continuously, when the operating system and the application programs of the computer system are performing.

Mode S1: Provide the powers to the central processing unit (CPU) and other components, continuously, when the CPU stops performing instructions.

Mode S2: Stop providing the powers to the CPU and provide the powers to other components.

Mode S3: Provide the powers to memories and stop providing the powers to other components.

Mode S4: Write data of the memories to a hard-drive and stop providing the powers to all of the components.

Mode S5: Turn off all of the components.

In the conventional ACPI, the chip set (e.g. a south bridge chip set) utilized for performing an ACPI operating system in the electronic products (e.g. the laptops and tablets) can only be coupled to a single computing device (e.g. an embedded controller). The hardware devices (e.g. a fan, a battery and a temperature management chip) are coupled to the computing device to control the chip set to perform specific events via the computing device. The computing device may be coupled to the hardware devices via inter-integrated circuit (I2C) interface or general purpose input/output (GPIO) pins. When a number of the hardware devices coupled to the computing device increases, the GPIO pins may be not enough for all of the hardware devices and the accessing performance of the I2C interface is downgraded. In such a condition, if some of the hardware devices are directly coupled to the GPIO pins of the chip set, additional filters are required to be configured between the hardware devices and the chip set to filter noises. The cost of the electronic products would be significantly increased if the number of the hardware devices directly coupled to the chip set increases. In addition, the accessing performance of the I2C interface would be also downgraded if the hardware devices are coupled to the chip set via the I2C interface of the chip set. Therefore, how to improve the operation efficiency of the chip set when the number of the hardware devices in the electronic product increases becomes a topic to be discussed.

### SUMMARY OF THE INVENTION

In order to solve the above problem, the present invention provides a chip device utilizing general purpose input/output pins to replace a system control interrupt pin and electronic system thereof.

An embodiment of the invention discloses a Chip device, for performing an Advanced Configuration and Power Interface (ACPI) operating system, the chip device comprising a first event pin, coupled to a first computing device for receiving a first event signal; and a first clock pin, coupled to the first computing device for receiving a first clock signal; wherein the chip device performs a first event according to the first event signal and the first clock signal.

An embodiment of the invention further discloses an electronic system, comprising a chip device, for operating an Advanced Configuration and Power Interface (ACPI) operating system; and a first computing device, coupled to the chip device via a first event pin and a first clock pin; wherein the first computing device transmits a first event signal to the chip device via the first event pin and transmits a first clock signal to the chip device via the first clock pin, for controlling the chip device to perform a first event.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic system according to an embodiment of the invention.

FIG. 2 is a schematic diagram of related signals when the electronic system shown in FIG. 1 operates.

FIG. 3 is a schematic diagram of related signals when the electronic system shown in FIG. 1 operates.

FIG. 4 is a flowchart of a process according to an embodiment of the invention.

### DETAILED DESCRIPTION

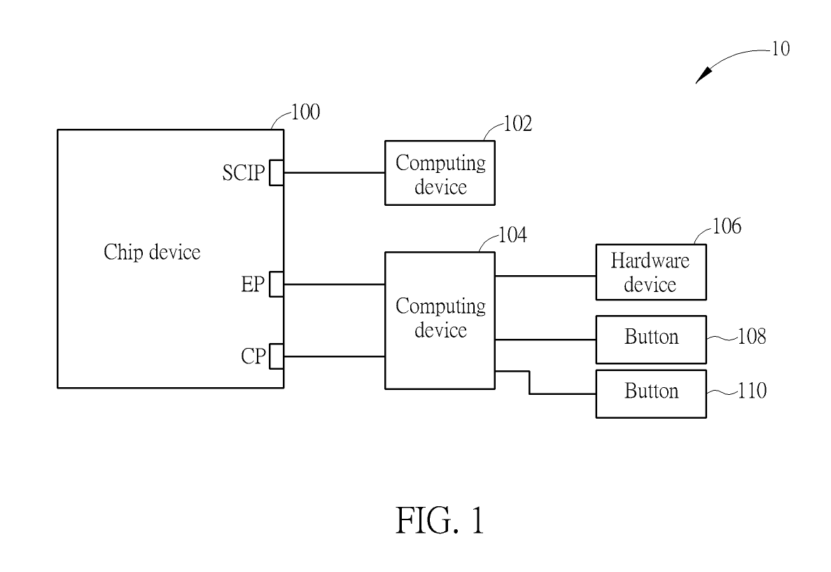

Please refer to FIG. 1, which is a schematic diagram of an electronic system 10 according to an embodiment of the invention. The electronic system 10 may be an electronic product such as a notebook, a tablet, a personal computer and a smart phone. As shown in FIG. 1, the electronic system 10 comprises a chip device 100, computing devices 102 and 104. The chip device 100 is utilized for performing an Advanced Configuration and Power Interface (ACPI) operating system. For example, the chip device 100 may be a south bridge chip set, and is not limited herein. The computing devices 102 and 104 may be processing devices such as the microprocessors, single chip microcontrollers and the embedded controllers, and are not limited herein. The computing device 102 is coupled to the chip device 100 via a system control interrupt (SCI) pin SCIP. Note that, the chip device 100 only equips the single SCI pin SCIP according to specifications of the ACPI operating system. In such a condition, the computing device 104 cannot be coupled to chip device 100 via the SCI pin SCIP and is coupled to the chip device 100 via an event pin EP and a clock pin CP. The computing device 104 instructs the chip device 100 to perform specific events via an event signal ES transmitted in the event pin EP and a clock signal CS transmitted in the clock pin CP. As a result, the chip device 100 for performing the ACPI operating system can be coupled to multiple computing devices (e.g. computing devices 102 and 104), to improve a communication efficiency between hardware devices in the electronic system 10 and the chip device 100.

In details, the computing device 102 is not only coupled to the chip device 100 via the SCI pin SCIP but also coupled to the hardware devices of the electronic devices, such as a fan, a battery or a temperature management chip (not shown in FIG. 1), via inter-integrated circuit I2C interface or general purpose input/output (GPIO) pins. In such a condition, when the hardware devices coupled to the computing device 102 requires controlling the chip device 100 to perform an event QE, the computing device 102 instructs the chip device 100, via the SCI pin SCIP, to receive an event number QEN of the event QE via specific ports (e.g. ports 62 and 66). The chip device 100 performs the event QE according to the event number QE, accordingly. The operation principles of the computing device 102 communicates with the chip device 100 via the SCI pin SCIP to control the chip device 100 to perform the event QE should be well known to those skilled in the art, and are not narrated herein for brevity.

On the other hand, the computing device 104 is coupled to a hardware device 106 (e.g. a fan, a battery or a temperature management chip) via an I2C interface and buttons 108 and 110 of the electronic system 10 via GPIO pins. When the hardware device 106, the buttons 108 or 110 require controlling the chip device 100 to perform an event LE, the computing device 104 transmits the event signal ES and the clock signal CS to the chip device 100 in the event pin EP and the clock pin CP, respectively, wherein the event pin EP and the clock pin CP are the GPIO pins of the chip device 100. The computing device 104 first transmits a start bit S in the clock signal CS, to trigger an interrupt for indicating the chip device 100 that the operating device 104 is ready to transmit an event number LEN of the event LE in the event signal ES. Next, the chip device 100 samples the event signal ES each time of the clock signal CS indicates (e.g. triggers) the interrupt, to acquire a bit of the event number LEN. When a number of times of the clock signal CS indicates the interrupt (i.e. a number of times of the chip device 100 samples the event signal ES) reaches a predetermined value TH, the chip device 100 determines that the complete event number LEN is completely received and performs the event LE according to the event number LEN. As a result, the computing device 104 controls the chip device 100 to perform the event LE required by the hardware device 106, the buttons 108 or 110 via the event pin EP and the clock pin CP. When the number of the hardware devices in the electronic system 10, the operation efficiency of the electronic system 10 can be improved by the computing device 104 which is coupled to the chip device 100 via the GPIO pins.

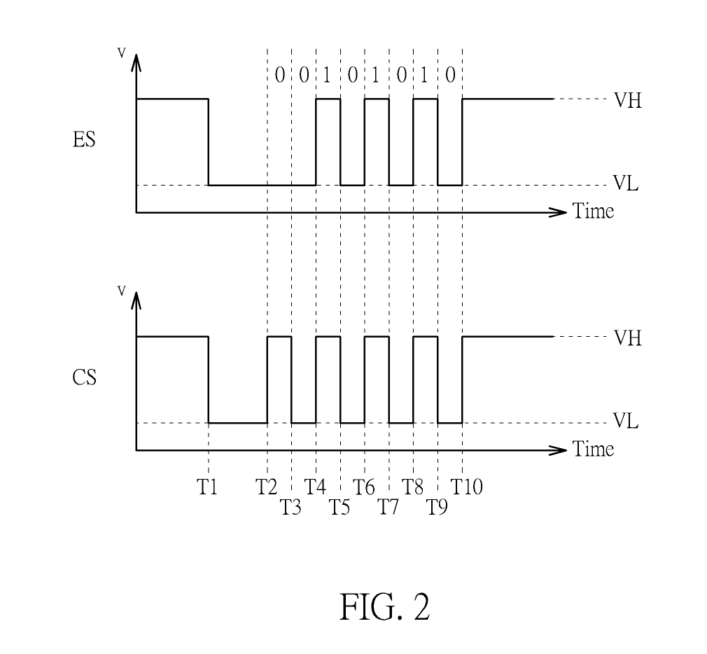

Please refer to FIG. 2, which is a schematic diagram of related signals when the electronic system 10 shown in FIG. 1 operates. As shown in FIG. 2, the clock signal CS decreases to a low-logic voltage VL corresponding to the logic level ‘0’ from a high logic voltage VH corresponding to the logic level ‘1’. In an embodiment, the high logic voltage VH is the maximum voltage (e.g. a voltage of the power) in the electronic system 10 and the low logic voltage VL is the voltage of ground. In such a condition, the chip device 100 determines the clock signal CS transmits the start bit S (i.e. triggers the interrupt), and adjusts the condition of triggering the interrupt to that when the clock signal CS switches from the low logic voltage VL to the high logic voltage VH. Next, the clock signal CS switches from the low logic voltage VL to the high logic voltage VH at a time T2. The chip device 100 therefore determines the clock signal CS indicates the interrupt, samples the event signal ES, and acquires a bit ‘0’ as a first bit of the event number LEN. After sampling the event number ES at the time T2, the chip device 100 adjusts the interrupt condition to that when the clock signal CS switches from the high logic voltage VH to the low logic voltage VL, to reduce the time of acquiring the event number LEN. The clock signal CS switches from the high logic voltage VH to the low logic voltage VL at a time T3, the chip device 100 determines the clock signal CS indicates an interrupt, samples the event signal ES, acquires a bit ‘0’ as a second bit of the event number LEN, and so on. Finally, the chip device 100 performs the event LE according to the event number LEN after acquiring an eighth bit of the event number LEN at a time T9 (i.e. the predetermined value TH is 8).

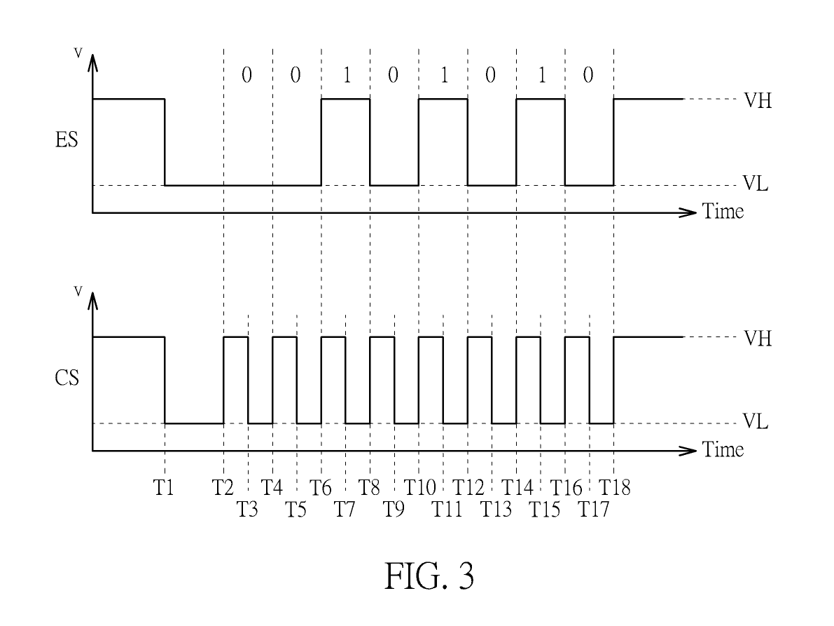

Note that, the chip device 100 may not change the condition of triggering the interrupt. In such a condition, the chip device 100 determines the clock signal CS indicates the interrupt each time of the clock signal CS switches from the high logic voltage VH to the low logic level VL and performs the corresponded operations. Please refer to FIG. 3, which is a schematic diagram of related signals when the electronic system 10 shown in FIG. 1 operates. Similar to FIG. 2, the clock signal CS decreases from the high logic voltage VH corresponding to the logic level ‘1’ to the low logic voltage VL corresponding to the logic level ‘0’ at the time T1 and the chip device 100 determines the clock signal CS transmits the start bit. Different from FIG. 2, the chip device 100 does not change the condition of the clock signal CS indicates the interrupt to that when the clock signal CS switches from the low logic voltage VL to the high logic voltage VH in this embodiment. In such a condition, the chip device 100 does not trigger the interrupt when the clock signal CS switches from the low logic voltage VL to the high logic voltage VH at the time T2. When the clock signal CS switches from the high logic voltage VH to the low logic voltage VL at the time T3, the chip device 100 determines the clock signal CS indicate triggering the interrupt. The chip device 100 samples the event signal ES, acquires the bit ‘0’ as the first bit of the event number LEN, and so on. In other words, the chip device 100 samples the event signal ES only when the clock signal CS switches from the high logic voltage VH to the low logic voltage VL in this embodiment. As a result, the chip device 100 also can acquire the correct event number LEN and perform the corresponded event LE.

In the above embodiment, the chip device is not only coupled to a computing device via the SCI pin but also coupled to another computing device via 2 GPIO pins. As a result, a number of the hardware devices coupled to single computing device can be reduced when the number of the hardware devices required to be coupled to the chip device increases. The communication efficiency between the chip device and the hardware devices can be therefore improved. According to different applications and design concepts, those with ordinary skill in the art may observe appropriate alternations and modifications. For example, when the number of the hardware devices in the electronic system 10 further increases resulting in the communication efficiency between the chip device 100 and the hardware devices is downgraded, another computing device may be added into the electronic system 10 and be coupled to the chip device 100 via 2 GPIO pins, to reduce the average number of hardware devices coupled to the single computing device. The communication efficiency between the chip device 100 and the hardware devices can be improved, therefore.

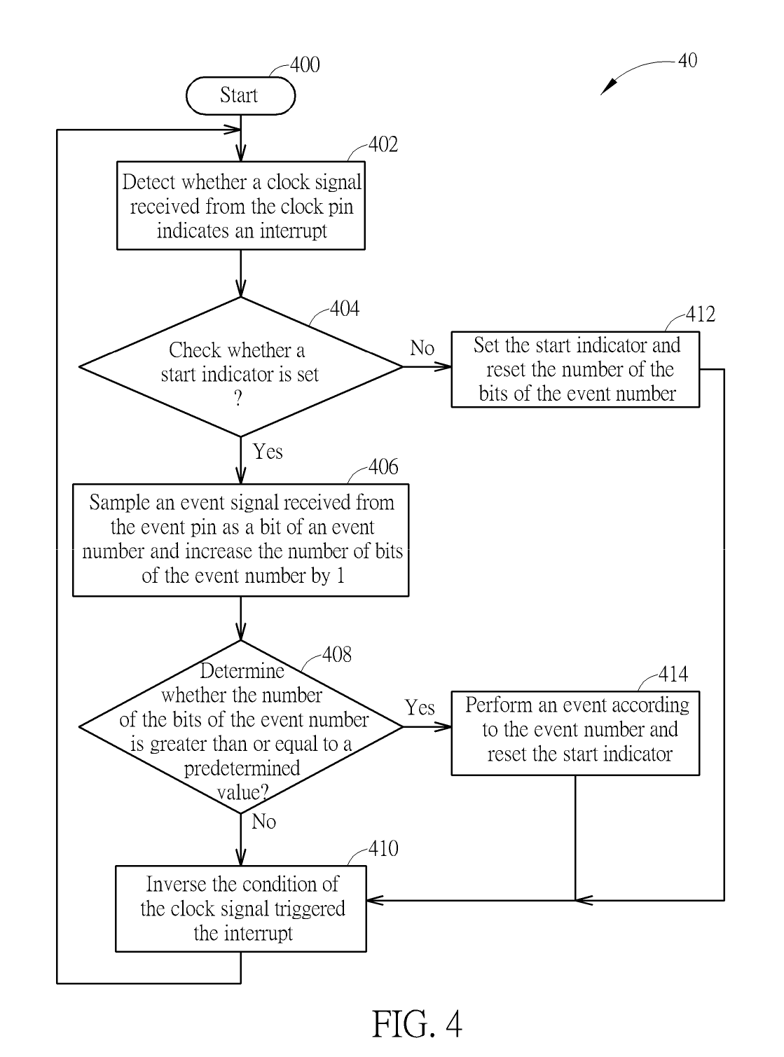

The communication method of the chip device 100 and the computing device 104 can be summarized into a process 40 shown in FIG. 4. The process 40 may be utilized in a chip device operating the ACPI operating system, wherein the chip device is coupled to a computing device via a clock pin and an event pin. The process 40 comprises the following steps:

Step 400: Start.

Step 402: Detect whether a clock signal received from the clock pin indicates an interrupt, if yes, perform step 404; otherwise, perform step 402.

Step 404: Check whether a start indicator is set, if the start indicator is set, perform step 406; otherwise, perform step 412.

Step 406: Sample an event signal received from the event pin as a bit of an event number and increase the number of bits of the event number by 1.

Step 408: Determine whether the number of the bits of the event number is greater than or equal to a predetermined value, if the number of the bits of the event number is greater than or equal to a predetermined value, perform step 414; otherwise, perform step 410.

Step 410: Inverse the condition of the clock signal triggered the interrupt.

Step 412: Set the start indicator and reset the number of the bits of the event number.

Step 414: Perform an event according to the event number and reset the start indicator.

According to the process 40, the chip device first detects whether the clock signal transmitted in the clock pin indicates an interrupt (e.g. detect whether the clock signal decrease from a high logic voltage to a low logic voltage) (step 402). When the clock signal indicates the interrupt, the chip device checks whether a start indicator is set (step 404). When the start indicator is not set (e.g. when the start indicator is at the logic level ‘0’), the chip device does not start recording an event number and the chip device sets the start indicator and reset a number of bits of the event number to 0 (step 412). When the start indicator is set (e.g. when the start indicator is at the logic level ‘1’), the chip device sample an event signal transmitted in the event pin as a bit of the event number and increases the number of the bits of the event number by 1 (step 406). Next, when the number of the bits of the event number reaches a predetermined value (e.g. 8), the chip device determines the complete event number has been received. The chip device therefore performs an event according to the event number and reset the start indicator (step 414); otherwise, the chip device does not perform other operations (step 408). Each time of the clock signal triggers the interrupt, the chip device inverses the condition of the clock signal triggers the interrupt (e.g. changes from “the clock signal decreases from the high logic voltage to the low logic voltage” to “the clock signal increases from the low logic voltage to the high logic voltage”), to reduce the time of acquiring the event number (step 410). Accordingly, the computing device controls the chip device to perform specific events via the clock pins and the event pins. In other words, the chip device utilizes 2 pins (e.g. 2 GPIO pins) to replace the SCI pin and to communicate with the computing device.

To sum up, the chip device of the above embodiments is not only coupled to a computing device via the SCI pin but also coupled to another computing device via 2 GPIO pins. As a result, when the number of the hardware devices in the electronic system requiring to be coupled to the chip device increases, the number of the hardware devices coupled to single computing device can be reduced and the communication efficiency between the chip device and the hardware devices can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic system, comprising:
a chip device, for operating an Advanced Configuration and Power Interface (ACPI) operating system; and
a first computing device, coupled to the chip device via a first event pin and a first clock pin;
wherein the first computing device transmits a first event signal to the chip device via the first event pin and transmits a first clock signal to the chip device via the first clock pin, for controlling the chip device to perform a first event.

2. The electronic system of claim 1, further comprising:
a second computing device, coupled to the chip device via a system control interrupt pin.

3. The electronic system of claim 1, wherein the first computing device is one of a microprocessor, a single chip microcontroller and an embedded controller.

4. The electronic system of claim 1, wherein the first event pin and the first clock pin are general purpose input/output pins.

5. The electronic system of claim 1, wherein the chip device samples the first event signal each time the first clock signal indicates an interrupt after the first clock signal indicates a start bit, to acquire a bit of an event number; and the chip device performs the first event according to the event number when a number of times of sampling the first event signal reaches a predetermined value.

6. The electronic system of claim 1, wherein the first computing device is further coupled to at least one of a fan, a battery, a temperature management chip and a plurality of buttons of the electronic system.

7. The electronic system of claim 1, further comprising:
a second computing device, coupled to the chip device via a second event pin and a second clock pin;
wherein the second computing device transmits a second event signal to the chip device via the second event pin and transmits a second clock signal to the chip device via the second clock pin, for controlling the chip device to perform a second event.

8. A Chip device, for performing an Advanced Configuration and Power Interface (ACPI) operating system, the chip device comprising:
a first event pin, coupled to a first computing device for receiving a first event signal; and
a first clock pin, coupled to the first computing device for receiving a first clock signal;
wherein the chip device performs a first event according to the first event signal and the first clock signal.

9. The chip device of claim 8, further comprising:
a system control interrupt pin, coupled to a second computing device.

10. The chip device of claim 8, the first computing device is one of a microprocessor, a single chip microcontroller and an embedded controller.

11. The chip device of claim 8, wherein the first event pin and the first clock pin are general purpose input/output pins.

12. The chip device of claim 8, wherein the chip device samples the first event signal each time of the first clock signal indicates an interrupt after the first clock signal indicates a start bit, to acquire a bit of an event number; and performs the first event according to the event number when a number of a times of sampling the first event signal reaches a predetermined value.

13. The chip device of claim 8, wherein the first computing device is further coupled to at least one of a fan, a battery, a temperature management chip and a plurality of buttons.

14. The chip device of claim 8, further comprising:
a second event pin, coupled to a second computing device for receiving a second event number; and
a second clock pin, coupled to the second computing device for receiving a second clock signal;
wherein the chip device performs a second event according to the second event signal and the second clock signal.
